(19) United States
(12) Patent Application Publication
(10) Pub. No.: US 2005/0220044 A1
(43) Pub. Date: Oct. 6, 2005

(54) Method and apparatus for performing bringup simulation in a mobile terminal

(75) Inventors: Kyu-Hyun Choi, Uijeongbu-si (KR); Joon-Sang Ryu, Suwon-si (KR); Kyo-Sook Shin, Suwon-si (KR); Hun-Kee Kim, Seoul (KR); Joo-Kwang Kim, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/092,714

(22) Filed: Mar. 30, 2005

(30) Foreign Application Priority Data
Mar. 31, 2004 (KR) 2004-22428

(51) Int. Cl. H04B 7/00

(52) U.S. Cl. 370/310

(57) ABSTRACT

An apparatus and method for performing a bring-up simulation to bring up a character are provided. In the apparatus, a sensor measures at least one of an ambient temperature of the mobile terminal, a remaining battery power of the mobile terminal and an amount of vibrations of the mobile terminal, a controller compares the measured value received from the sensor with a predetermined threshold, calculates bonus points and penalty points according to the measured value, and controls the state of a character according to the calculated bonus and penalty points, character generator sets or updates the state of the character according to internal conditions of the mobile terminal, external conditions of the mobile terminal and user interaction with the character via the mobile terminal corresponding to a control signal received from the controller, and a display for displaying the character in accordance with the state and growth stage of the character.

### PRIORITY

This application claims the benefit under 35 U.S.C. § 119(a) of an application entitled “Method and Apparatus for Performing Bring-Up Simulation in a Mobile Terminal” filed in the Korean Intellectual Property Office on Mar. 31, 2004 and assigned Ser. No. 2004-22428, the entire contents of which are incorporated herein by reference.

### BACKGROUND OF THE INVENTION

1. Field of the Invention

The present invention relates generally to an additional service available for a mobile terminal. In particular, the present invention relates to an apparatus and method for performing a bring-up simulation to grow and/or raise a character.

2. Description of the Related Art

Aside from their basic call functionality, mobile terminals now also provide a variety of additional services including multimedia functionality and games. Mobile terminals that have the ability to provide reinforced multimedia service comprise camera phones, MPEG Audio Layer-3 (MP3) phones, and Bluetooth phones. These mobile terminals are preferable to Personal Computers (PCs) due to their portability. Compared to PCs, mobile terminals provide easy connectivity to another party irrespective of time and place and provide additional functions such as an electronic notebook and a phone book.

Mobile gaming is seen as an obvious area for providing an additional mobile service. However, mobile games have constraints in terms of hardware requirements because of the limited size of mobile terminals relative to that of PCs. Therefore, for mobile games, currently only block games at the level of Tetris™ are available due to hardware capacity and/or site limitations of such components as the Central Processing Unit (CPU), memory, and display.

On the other hand, games that can be played on a PC or any other electronic device include block (classic), arcade, adventure, strategy simulation, bring-up simulation (e.g., a nurturing or rearing simulation that simulates care for and growth of a character), role playing, and action when they are classified according to genre. They are also categorized into Multi-User Dungeon (MUD) and single user dungeon games according to the amount of players. A MUD game is played by a plurality of gamers through connections to a network, and a single user dungeon game is played by one gamer. Among those various games, the bring-up simulation is attracting more and more interest from gamers.

Accordingly, a need exists for techniques of providing a bring-up simulation from a mobile terminal as played on a PC or an electronic device in order to satisfy user demands and maximize the advantage of the mobile terminal. That is, a method of providing an upgraded bring-up simulation by use of hardware devices is needed.

### SUMMARY OF THE INVENTION

An object of the present invention is to substantially solve at least the above problems and/or disadvantages and to provide at least the advantages below. Accordingly, an object of the present invention is to provide a method and apparatus for providing a bring-up simulation game in a mobile terminal.

Another object of the present invention is to provide a method and apparatus for providing a bring-up simulation game in a mobile terminal based on information received from at least one sensor that senses the external environment and internal operational environment of the mobile terminal.

A further object of the present invention is to provide a method and apparatus for providing a bring-up simulation game based on bonus points and penalty points.

The above objects are achieved by providing an apparatus and method for performing a bring-up simulation to bring up a character.

According to one aspect of the present invention, in an apparatus for providing a bring-up simulation game in a mobile terminal, a sensor measures the ambient temperature of the mobile terminal, a controller compares the temperature measurement received from the sensor with a predetermined temperature threshold, calculates bonus points and penalty points according to the temperature measurement, and controls the state of a character according to the calculated bonus and penalty points, a character generator sets or updates the state of the character according to internal conditions of the mobile terminal, external conditions of the mobile terminal and user interaction with the character via the mobile terminal corresponding to a control signal received from the controller, and a display displays the character in accordance with the state and growth stage of the character.

According to another aspect of the present invention, in a method of providing a bring-up simulation game in a mobile terminal, selection of a bring-up simulation mode and selection of a character are sensed, bonus points and penalty points representing internal conditions of the mobile terminal, external conditions of the mobile terminal and user interaction with the character via the mobile terminal are collected based on information received from at least one sensor for sensing the external environment and the internal operational environment of the mobile terminal, a predetermined operation is computed using the bonus points and penalty points to change the state of the character, and the state of the character is increased by one level if the calculation result exceeds a predetermined threshold upper limit.

### BRIEF DESCRIPTION OF THE DRAWINGS

The above and other objects, features and advantages of the present invention will become more apparent from the following detailed description when taken in conjunction with the accompanying drawings in which:

FIG. 1A is a block diagram of a mobile terminal having a bring-up simulator according to an embodiment of the present invention;

FIG. 1B illustrates the exterior layout of the mobile terminal having a bring-up simulation function according to an embodiment of the present invention;

FIG. 2 illustrates an example of a screen display in the process of a bring-up simulation according to the present invention;

FIG. 3 is a flowchart illustrating an operation for performing a bring-up simulation according to an embodiment of the present invention;

FIG. 4 is a flowchart illustrating an operation for performing a bring-up simulation by sensing a petting motion according to an embodiment of the present invention;

FIG. 5 is a flowchart illustrating an operation for performing a bring-up simulation by sensing an ambient temperature according to an embodiment of the present invention;

FIG. 6 is a flowchart illustrating an operation for performing a bring-up simulation by measuring remaining battery power according to an embodiment of the present invention;

FIG. 7 is a flowchart illustrating an operation for performing a bring-up simulation by sensing vibrations according to an embodiment of the present invention; and

FIG. 8 is a flowchart illustrating an operation for performing a bring-up simulation by self-monitoring according to an embodiment of the present invention.

Throughout the drawings, the same element is designated by the same reference numeral or character.

### DETAILED DESCRIPTION OF EXEMPLARY EMBODIMENTS

Embodiments of the present invention will be described herein below with reference to the accompanying drawings. In the following description, well-known functions or constructions are not described in detail for conciseness.

The present invention provides a bring-up simulation game in a mobile terminal. A game character matures based on detected emotions such as the sympathy of a user. The bring-up simulation is not a simple software program. It reflects user actions that are indicative of emotions or feelings that are detected through sensors in raising and caring for the game character.

According to an embodiment of the present invention, the representation of mutual sympathy between the game character and the user is expanded to real human emotion by sensing vibrations, brightness and contrast, and temperature using sensors rather than only simple keypad manipulation.

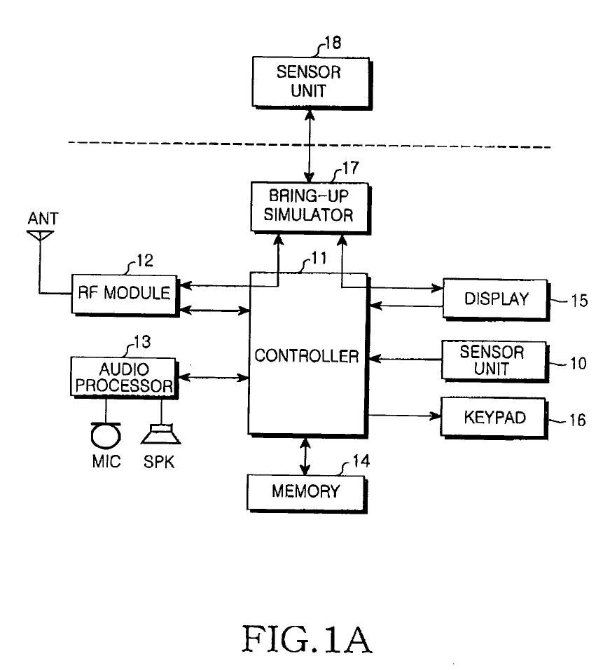

FIG. 1A is a block diagram of a mobile terminal with a bring-up simulator according to an embodiment of the present invention. The mobile terminal includes a sensor unit 10 for sensing vibrations, brightness and temperature, a controller 11, a Radio Frequency (RF) module 12, an audio processor 13, a memory 14, a display 15, a keypad 16, a bring-up simulator 17, and a character generator 18.

Referring to FIG. 1A, the controller 11 controls the mobile terminal and, particularly, controls the bring-up simulator 17 according to an embodiment of the present invention. The sensor unit 10 reports a measured ambient temperature to the controller 11 and the controller 11 compares the measured temperature with a predetermined threshold range for normal operation according to an embodiment of the present invention. Or the controller 10 controls character growth according to information about a brightness change received from the keypad 16. Or the controller 10 counts and compares the number of vibrations to a predetermined vibration threshold. That is, the controller 11 receives variables associated with character growth and/or raising received from the sensor unit 10 and applies a corresponding control signal to the bring-up simulator 17.

The RF module 12 downconverts an RF signal and outputs the downconverted signal to the controller 11 or the audio processor 13 according to the type of received data, under the control of the controller 11. The data that the RF module 12 provides to the controller 11 is data on a traffic channel, or a paging/signaling signal on a control channel. The data that the RF module 12 provides to the audio processor is voice data when a call is established.

The audio processor 13 is generally configured to be a vocoder and operates under the control of the controller 11. The audio processor 13 decodes and converts coded voice data received from the RF module 12 into an electrical voice signal and outputs it to a speaker (SPK). The speaker then converts the electrical voice signal to audible voice. Also, the voice processor 13 encodes an electrical voice signal received from a microphone (MIC) and outputs the coded voice signal to the RF module 12.

The memory 14 may include a Read Only Memory (ROM) and a Random Access Memory (RAM). It is divided into an area for storing data required for the control operation of the controller 11, an area for storing data entered by the user, and an area for temporarily controlling data generated during the control operation. Thus, the memory 14 is randomly accessible, readable and writable.

The display 15 includes a device for indicating operational states in characters or icons such as a Liquid Crystal Display (LCD), a vibration motor, and an alarm lamp. The LCD displays the bring-up simulation character in the process of character growing and/or raising and icons for manual management of the character growing.

The keypad 16 is typically configured in a key matrix structure. It includes alphanumerical keys for dialing and function keys for invoking functions. The keypad 16 provides key data corresponding to keys pressed by the user to the controller 11. However, it should be appreciated by those skilled in the art that the keypad can have other forms and structures without departing from the scope of the present invention.

The bring-up simulator 17 grows and/or raises the character according to control information received from the controller 12 and transmits information about the growth stage and current state of the character.

The character generator 18 generates the character using character generation data received from the RF module 12 or stored in the memory 14. The character generator 18 can be incorporated into the mobile terminal itself, or separately procured from a mobile communication network.

FIG. 1B illustrates the exterior layout of the mobile terminal having a bring-up simulation function according to an embodiment of the present invention. The illustrated mobile terminal is provided with a plurality of hardware sensors according to an embodiment of the present invention. While the hardware sensors can be integrated into a single sensor depending on system design, the following description is based on the use of separate sensors.

Referring to FIG. 1B, a character 31 is selected by the user and displayed on the display 15. A temperature sensor 32 measures the ambient temperature of the mobile terminal. A vibration sensor 33 measures the number of vibrations of the mobile terminal. A self-monitoring sensor 34 is a type of keypad, for monitoring the state of the mobile terminal. Similarly, a brightness sensor 36 comprising a set of sensors 36a, 36b and 36c can also function as a keypad. A battery check sensor 35 indicates on the display 15 the remaining amount of power of the mobile terminal.

As described above, the sensors 32 to 36 check the ambient temperature, battery state and the change in the amount of light or brightness of the mobile terminal, and the measurements are reflected as variables for growing and/or raising the character 31. That is, the state of the character 31 is adjusted according to the ambient temperature and battery state of the mobile terminal. Also, the state of the character 31 can be changed according to key inputs.

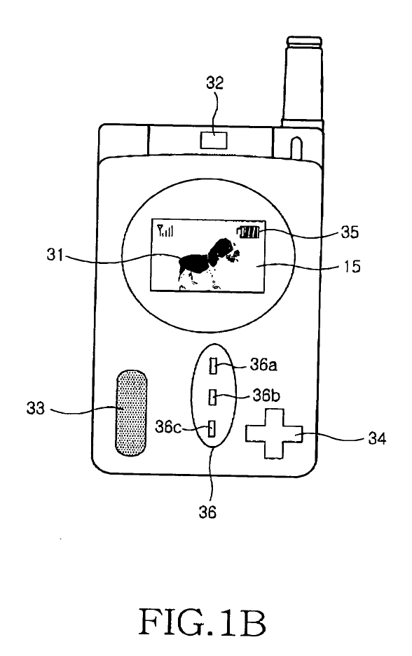

The operation of the sensors will be described in greater detail by taking an example of a character with reference to FIG. 2.

FIG. 2 illustrates an example of a screen display in the process of a bring-up simulation according to an embodiment of the present invention.

Referring to FIG. 2, the bring-up simulation simulates growing and/or raising and caring for a character like a pet dog. It should be appreciated by those skilled in the art that the present invention is not limited to animals. For example, plants, and humans can also be grown and/or raised and cared for.

A character 101 selected by the user is disposed at the center of the display 15. There are a plurality of icons by which to grow the character 101 according to a user interface. A scale icon 102 indicates the weight status of the character 101. A knife and fork icon 103 indicates the feeding status of the character 101 and can be used to manage the character 101 in connection with the battery power. A ball and bat icon 104, a restroom icon 105 represented by a duck, and an etiquette icon 106 function to strengthen the ties between the character 101 and the user. The user checks the state of the character 101 and plays a game with the character 101 using the ball and bat icon 104 or teaches etiquette to the character 101 using the etiquette icon 106. A syringe icon 107 is used to check the medical care status of the character 101 and a bulb icon 108 indicates the sleep status of the character 101. A face icon 109 is used to enhance the appearances of the character 101. A blood type icon 110 indicates the vital statistics status of the character 101. An alarm icon 111 indicates a sudden abnormality in the character 101. The functions associated with the character 101 can be changed by a system designer or according to user settings. For example, the functions are selectively downloaded from an external communication device, to thereby raise the character 101 better.

The embodiments of the present invention are intended to additionally provide the function of raising the character 101 according to inputs from hardware devices as well as by software rather using only software as is traditionally done.

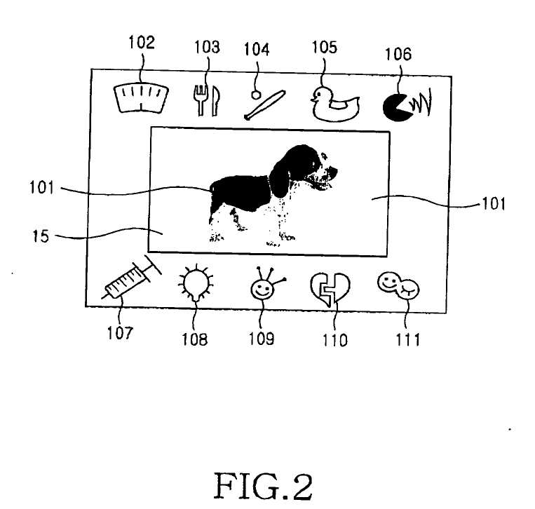

FIG. 3 is a flowchart illustrating an operation for performing a bring-up simulation according to an embodiment of the present invention.

Referring to FIG. 3, the controller receives key input corresponding to the selection of a bring-up simulation game from the keypad and enters into a character bring-up mode in step 204. In step 206, the controller prompts the user to register a particular character in an initial environment setting sub-mode of the character raising mode. The controller displays a character selected by the user from among a plurality of characters in step 208. The controller then receives information associated with the growing and/or raising and caring of the selected character through the sensors according to an embodiment of the present invention.

Specifically, the controller senses a petting motion through the brightness sensor in step 210, for example, the motions of a user hand passing above the sensor can be detected, which varies the amount of light being received by the sensor, senses the ambient temperature of the mobile terminal through the temperature sensor in step 212 for instance, the external and/or internal temperature of the mobile terminal can be determined, determines the health status of the character through the self-monitoring sensor in step 214, and senses a caring motion through the vibration sensor in step 216, for example, a user can rock the character back and forth which can be detected as a series of vibrations. In step 218, the controller senses whether the character 101 is in a hunger state through the battery check sensor.

As a way to grow and/or raise the character, bonus points are given for an action that has a positive effect on the character, and penalty points are given for an action that adversely affects the character. Thus, the character can be raised more efficiently based on the bonus and penalty points. In step 220, therefore, the controller collects the bonus and penalty points based on the results of steps 210 to 218 and controls the growth of the character by calculating
Accumulated Points=Bonus Points−Penalty Points (1)

The accumulated points are used to control the growth stage of the character. In an embodiment of the present invention, six growth stages are defined: stage 0 indicating death, stage 1 indicating babyhood, stage 2 indicating childhood, stage 3 indicating adolescence, stage 4 indicating manhood, stage 5: old age, and stage 6: angel. The appearances of the character for each growth stage are shown so that the user can easily determine the state or age of the character. The initial stage of the character is stage 1, that is, babyhood.

In step 220, the controller calculates bonus and penalty points by comparing the data measured by the sensors with their respective thresholds set for the sensors and calculates an accumulated point representing the current state of the character by subtracting the sum of penalty points from the sum of bonus points.

If the accumulated points exceed a predetermined threshold (e.g. +100) in step 222, the controller increases the growth stage of the character by one level in step 224 and determines whether the increased growth stage of the character is the last growth stage, that is, stage 6 in step 226 in an embodiment of the present invention. If the character is completely grown, the controller provides a congratulation message and music on the successful character growing and/or raising to the user in step 228. The congratulation message and music can be preset by the user or a software designer who has designed the bring-up simulation game. Then, the controller terminates the bring-up simulation procedure of the character in step 244.

In contrast, if the character growth stage is not the last stage in step 226, the controller displays the appearances of the character suitable for the growth stage corresponding to the accumulated point in step 230 and sets the bonus and penalty points to initial values in step 242. The current state is stored in step 240 and the method returns to steps 210, 212, 214, 216 and 218.

If the accumulated point is equal to or less than the threshold +100 in step 222, the controller determines whether the accumulated point is less than −100 in step 232. If it is, the controller decreases the growth stage of the character by one level in step 234. If the decreased growth stage is the initial one, that is, stage 0 in step 236, the controller sets the character growth stage as death in step 238.

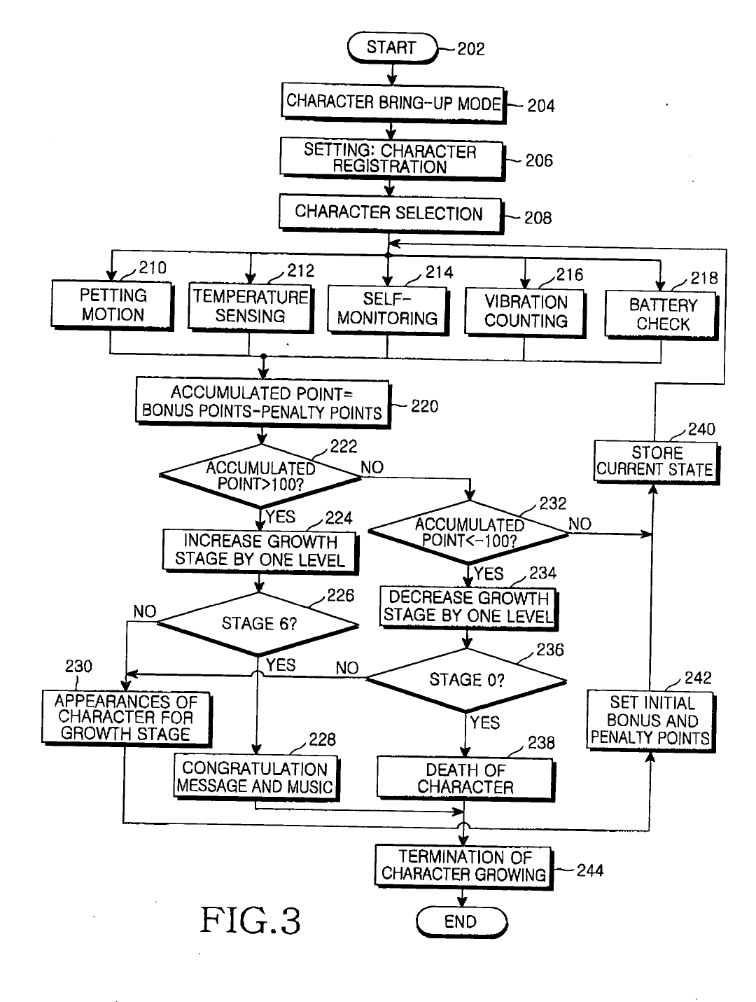

FIG. 4 is a flowchart illustrating an operation for performing a bring-up simulation by sensing a petting motion according to an embodiment of the present invention.

Referring to FIG. 4, the controller senses a bright-to-dark change through the brightness sensor 36 and controls the character to show a response to a petting motion. The brightness sensor 36 senses the brightness of the display 15. As illustrated in FIG. 1B, the brightness sensor 36 includes a set of sensors 36a, 36b and 36c. When the controller receives a key input in one direction with respect to the sensors 36a, 36b and 36c, that is, when the brightness sensor 36 senses sequential bright-to-dark changes, the controller considers the bright-to-dark changes as a petting motion for the character.

Therefore, the controller controls the character to appear pleased based on the information received form the brightness sensor 36 representing affection from the user. The controller can also provide an additional automatic turn-on/turn-off function by sensing the brightness around the mobile terminal through the brightness sensor 32.

The controller senses a bright-to-dark change through the first sensor 36ain step 402, another bright-to-dark change through the second sensor 36b in step 404, and a third bright-to-dark change through the third sensor 36c in step 406. If the user presses the brightness sensors in the reverse order, the controller senses the bright-to-dark changes sequentially through the brightness sensors 36c, 36band 36a.

The controller determines that the sequential bright-to-dark changes represent a petting motion on the character in step 414 and adds a bonus point in step 416.

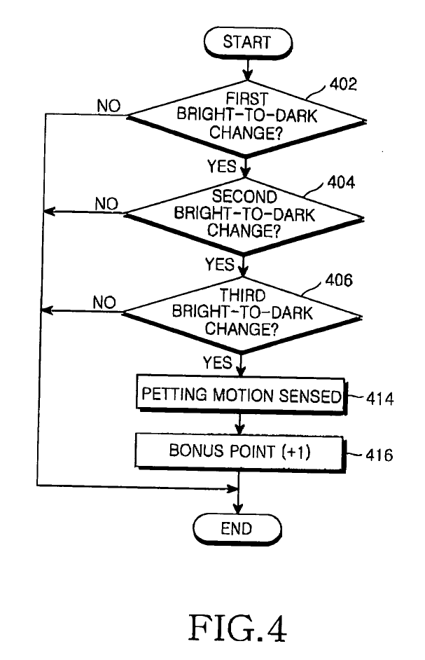

FIG. 5 is a flowchart illustrating an operation for performing a bring-up simulation by sensing temperature according to an embodiment of the present invention. The character raising function using the temperature sensor 32 guides the user to use the mobile terminal in a proper range of temperature by controlling the character to show dislike if a temperature measured by the temperature sensor 32 is outside the appropriate temperature range. It is known that the mobile terminal works normally at 0 to 40° C.

In this way, the controller measures an ambient temperature by the temperature sensor 32 and controls the growth of the character based on the temperature measurement. If the mobile terminal is left in a vehicle on a very hot summer day, or on a very cold winter day, the character makes a high-pitched effect sound in an alarm mode or the character shivers with cold. The life of the mobile terminal is lengthened by suppressing its use in an extreme temperature environment. Also, the ambient temperature of the mobile terminal can be detected via the external environment, for example.

Referring to FIG. 5, the temperature sensor measures the ambient temperature of the mobile terminal a predetermined time later in step 502. The time is preset by the system designer. The controller compares the temperature measurement with a predetermined threshold range in step 504. If the temperature measurement is lower than 40° C., the controller goes to step 506. If it is above 40° C., the controller controls the character to pant from heat in step 512.

If the temperature measurement is 0° C. or above in step 506, the controller leaves the character as it is because the mobile terminal is in a normal temperature range in step 508. If the temperature measurement is below 0° C., the controller controls the character to shiver with cold in step 510.

After step 510 or step 512, the controller adds a penalty point in relation to the growth of the character in step 514.

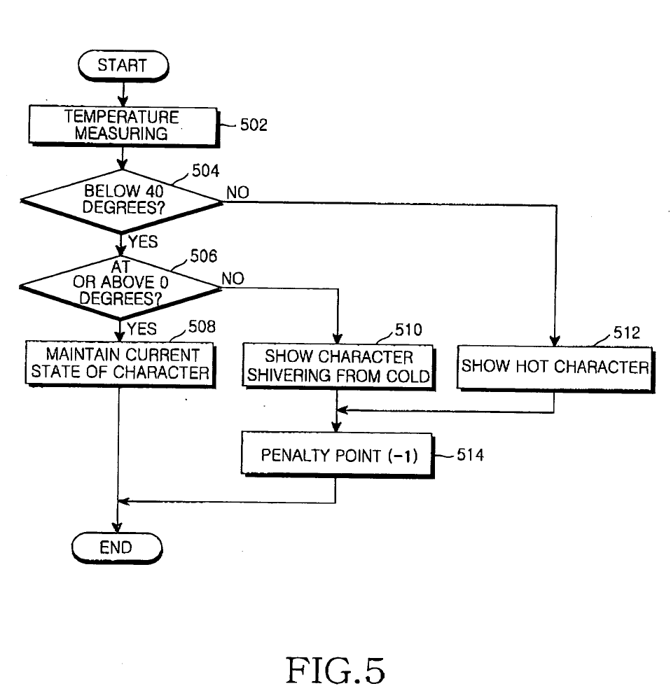

FIG. 6 is a flowchart illustrating an operation for performing a bring-up simulation by measuring remaining battery power according to an embodiment of the present invention. The remaining power of the battery is measured based on a varying battery level basis and the user is notified that it is time to feed the character according to the remaining battery power. The notification can be made by outputting a special effect sound in an alarm mode or vibrations in a vibration mode. The user then charges the battery in response to the character feeding request.

Referring to FIG. 6, the remaining battery power is measured as one of five levels, level 1 indicating minimal power to level 5 indicating full power. In step 602, the remaining battery power is measured. If the battery power is at one of level 2 to level 5 in steps 604 to 612, the controller updates the appearances of the character according to the power level, considering that the batter power exceeds a threshold in step 613. On the contrary, if the battery power is at level 1 in step 614, the controller controls the character to appear weak from hunger in step 616. If a predetermined time elapses in step 618 and the user tries to charge the battery in step 620, the controller adds a bonus point for the growth of the character in step 622.

Upon sensing that the battery is charged from an initial low power level, the controller determines that the hungry character is fed and cared for. Therefore, the controller gives a bonus point for the growth and/or raising of the character. On the other hand, if the battery is not charged in step 620, the controller gives a penalty point for the character in step 624. That is, the controller decreases the bring-up simulation point for careless treatment of the hungry character.

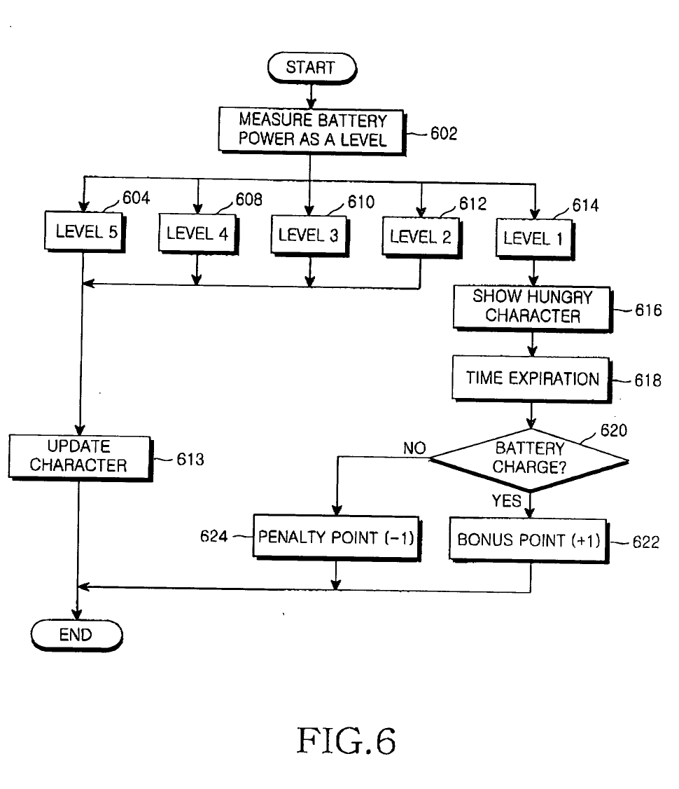

FIG. 7 is a flowchart illustrating an operation for performing a bring-up simulation by counting vibrations according to an embodiment of the present invention. When the mobile terminal is shaken, the vibration sensor 33 senses the vibration and the controller considers that the user plays with the character. The idea is related to the fact that kids enjoy being held and moved about. Thus, the character can be shown to play with the user based on the vibrations sensed by the vibration sensor. The vibration sensor can be implemented as a step counter in the mobile terminal. The steps of the user are counted using the step counter function and reflected in the health state of the character, thereby maximizing the growth of the character.

Referring to FIG. 7, the vibrations of the mobile terminal are counted by the vibration sensor in step 702. In step 704, the controller gives a bonus point if the count exceeds a predetermined vibration threshold. The threshold is set by the system designer.

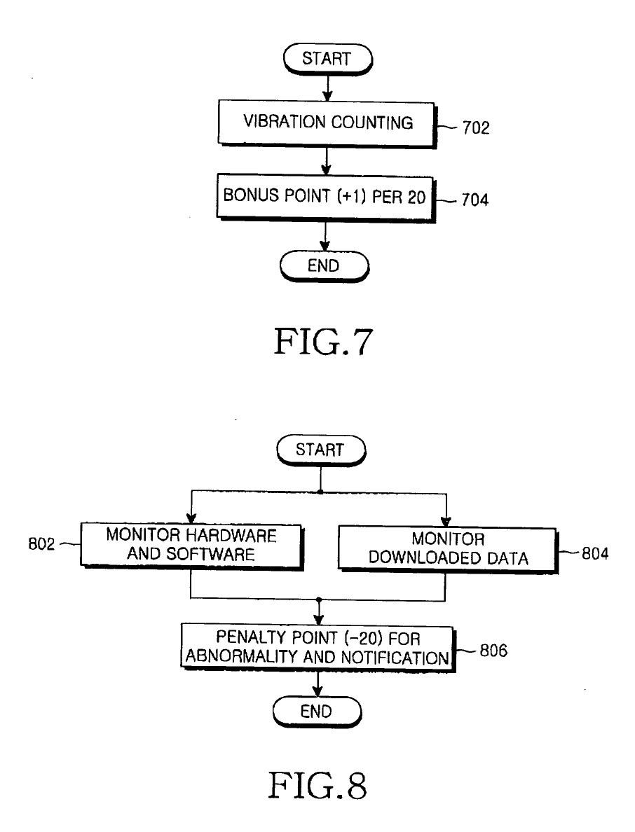

FIG. 8 is a flowchart illustrating an operation for performing a bring-up simulation based on self-monitoring according to an embodiment of the present invention.

The self-monitoring sensor 34 automatically senses the presence of bugs in downloaded data including games, bell sounds, or music video, abnormality in hardware, or defects in the LCD and the controller correspondingly controls the character to appear to be sick. That is, when defects are generated in the mobile terminal, the controller quickly detects them through the self-monitoring sensor.

Referring to FIG. 8, the self-monitoring sensor monitors hardware devices and software in step 802, or monitors downloaded data in step 804. If errors are detected in step 802 or step 804, the controller adds penalty points and notifies the user of the abnormality via an audible or visual alarm in the alarm mode or by vibrations in the vibration mode in step 806.

In accordance with embodiments of the present invention as described above, a bring-up simulation game is played by taking into account input variables from hardware devices as well as a software program which was only considered in conventional technology. Therefore, the bring-up simulation game becomes more realistic, maximizing user interfacing. Consequently, the utilization of a mobile terminal is increased.

While the invention has been shown and described with reference to certain embodiments thereof, it will be understood by those skilled in the art that various changes in form and details may be made therein without departing from the spirit and scope of the invention as defined by the appended claims.

1. An apparatus for providing a bring-up simulation game in a mobile terminal, comprising:
a sensor for measuring at least one of an ambient temperature of the mobile terminal, a remaining battery power of the mobile terminal and an amount of vibrations of the mobile terminal;
a controller for comparing the measured value received from the sensor with a respective predetermined threshold, calculating bonus points and penalty points according to the measured value, and controlling the state of a character according to the calculated bonus and penalty points;
a character generator for setting or updating the state of the character according to internal conditions of the mobile terminal, external conditions of the mobile terminal and user interaction with the character via the mobile terminal corresponding to a control signal received from the controller; and
a display for displaying the character in accordance with the state and growth stage of the character.

2. The apparatus of claim 1, wherein the character generator is provided internally or externally.

3. The apparatus of claim 2, wherein the character generator is provided externally via character generation data downloaded from an external mobile communication network.

4. The apparatus of claim 2, wherein the character generator comprises a user interface for reflecting user intention for setting the state of the character.

5. The apparatus of claim 2, wherein the controller changes the state of the character so that the initial character appears hot if the measured temperature exceeds an upper temperature limit of the threshold.

6. The apparatus of claim 2, wherein the controller changes the state of the initial character so that the initial character appears cold if the measured temperature is lower than a lower temperature limit of the threshold.

7. The apparatus of claim 1, wherein if a battery power measurement is at a level requiring battery charging, the controller changes the state of the character so that the initial character appears hungry.

8. The apparatus of claim 7, wherein if the battery is charged a predetermined time later, the controller gives a bonus point according to the state of the character.

9. The apparatus of claim 7, wherein if the battery remains uncharged for the predetermined time, the controller gives a penalty point according to the state of the character.

10. The apparatus of claim 1, wherein the internal conditions of the mobile terminal, the external conditions of the mobile terminal and the user interaction with the character via the mobile terminal are indicators of a health status of the character and of an emotional attachment to the character by the user.

11. An apparatus for providing a bring-up simulation game in a mobile terminal, comprising:
a sensor for monitoring errors in downloaded software and hardware operation;
a controller for, upon detection of errors by the sensor, allocating penalty points as a variable for changing the state of a character;
a character generator for setting or updating the state of the character according to internal conditions of the mobile terminal, external conditions of the mobile terminal and user interaction with the character via the mobile terminal corresponding to a control signal received from the controller; and
a display for displaying the character in accordance with the state and growth stage of the character under the control of the controller.

12. An apparatus for providing a bring-up simulation game in a mobile terminal, comprising:
at least one sensor for sensing the brightness of a display in the mobile terminal;
a controller for receiving brightness information sequentially from the at least one sensor, allocating bonus points as a variable for changing the state of a character;
a character generator for setting or updating the state of the character according to internal conditions of the mobile terminal, external conditions of the mobile terminal and user interaction with the character via the mobile terminal corresponding to a control signal received from the controller; and
the display for displaying the character in accordance with the state and growth stage of the character under the control of the controller.

13. The apparatus of claim 12, wherein the at least one sensor is serially connected to the controller.

14. A method of providing a bring-up simulation game in a mobile terminal, comprising the steps of:
(1) sensing a selection of a bring-up simulation mode and selection of a character;
(2) collecting bonus points and penalty points representing varying stages of health of the character or received affection from a user based on information received from the at least one sensor for sensing an external environment and an internal operational environment of the mobile terminal, and calculating a predetermined operation using the bonus points and penalty points to change the state of the character; and
(3) increasing the state of the character by one level if the calculation result exceeds a predetermined threshold upper limit.

15. The method of claim 14, further comprising the step of decreasing the state of the character by one level if the calculation result is lower than a predetermined threshold lower limit.

16. The method of claim 14, further comprising the step of indicating a successful bring-up simulation if the state of the character corresponds to a complete growth state.

17. The method of claim 15, further comprising the step of processing the character as dead if the character is placed in a growth state that cannot be achieved.

18. The method of claim 16, further comprising the step of setting bonus and penalty points to initial values after the notification.

19. The method of claim 14, wherein the step of (1) further comprises the step of performing at least one of measuring the ambient temperature of the mobile terminal, measuring an amount of remaining battery power of the mobile terminal, measuring an amount of vibrations of the mobile terminal, monitoring errors in downloaded software and hardware operations, and sensing the brightness of a display in the mobile terminal.
